(19) United States
(12) Patent Application Publication
(10) Pub. No.: US 2026/0204665 A1
(43) Pub. Date: Jul. 16, 2026

(54) POWER STORAGE DEVICE

(71) Applicant: TOYOTA JIDOSHA KABUSHIKI KAISHA, Toyota-shi (JP)

(72) Inventor: Yuya ANDO, Ichinomiya-shi (JP)

(73) Assignee: TOYOTA JIDOSHA KABUSHIKI KAISHA, Toyota-shi (JP)

(21) Appl. No.: 19/413,065

(22) Filed: Dec. 9, 2025

(30) Foreign Application Priority Data
Jan. 16, 2025 (JP) 2025-006018

(51) Int. Cl. H01M 10/42; H01M 50/249; B60L 58/22

(52) U.S. Cl. CPC H01M 10/425; H01M 50/249; B60L 58/22; H01M 2220/20

(57) ABSTRACT

A power storage device includes: a power storage module including a plurality of power storage cells; and a battery ECU configured to execute an equalization process for equalizing SOCs of the power storage cells. The battery ECU is configured to, when a self-discharge amount of the power storage module per unit period is defined as a unit discharge amount and a period until the equalization process is executed next time is defined as a standby period, set the standby period when the unit discharge amount is large to be shorter than the standby period when the unit discharge amount is small.

### CROSS-REFERENCE TO RELATED APPLICATION

This application claims priority to Japanese Patent Application No. 2025-006018 filed on January 16, 2025. The disclosure of the above-identified application, including the specification, drawings, and claims, is incorporated by reference herein in its entirety.

### BACKGROUND

### 1. Technical Field

The present disclosure relates to a power storage device.

### 2. Description of Related Art

Japanese Unexamined Patent Application Publication (Translation of PCT Application) No. 2024-507529 (JP 2024-507529 A) discloses a system that executes a balancing process for equalizing the states of charge (SOCs) of a plurality of batteries connected in series.

### SUMMARY

Although description is not given in JP 2024-507529 A, when a battery is left unused for a long period of time, the discharge amounts of cells vary, resulting in a difference in SOC between the cells. To eliminate the difference in SOC between the cells, the balancing process (equalization process) may be executed. When the equalization process is executed excessively frequently, there arise problems such as an increase in power consumption from a power storage device. When the frequency of the equalization process is excessively low, the difference in SOC cannot be eliminated. Therefore, it is desirable to execute the equalization process at an appropriate frequency while the battery (power storage device) is left unused.

The present disclosure has been made to solve the above problems, and has an object to provide a power storage device that can execute an equalization process at an appropriate frequency while the power storage device is left unused.

The power storage device according to one aspect of the present disclosure is a power storage device attachable to and detachable from an electrical device. The power storage device includes: a power storage module including a plurality of power storage cells; and a control unit configured to execute an equalization process for equalizing states of charge of the power storage cells. The control unit is configured to, when a self-discharge amount of the power storage module per unit period is defined as a unit discharge amount and a period until the equalization process is executed next time is defined as a standby period, set the standby period when the unit discharge amount is large to be shorter than the standby period when the unit discharge amount is small.

In the power storage device according to the one aspect of the present disclosure, as described above, the standby period when the unit discharge amount is large is set to be shorter than the standby period when the unit discharge amount is small. As the unit discharge amount increases, the state of charge is more likely to vary. With the above configuration, the frequency of the equalization process when the variation in state of charge is large can be made higher than the frequency of the equalization process when the variation in state of charge is small. Thus, the variation in state of charge can be suppressed effectively. When the variation in state of charge is small, excessive execution of the equalization process can be suppressed. As a result, an increase in power consumption from the power storage device due to the equalization process can be suppressed. By setting the standby period when the unit discharge amount is large to be shorter than the standby period when the unit discharge amount is small, the equalization process can be executed at an appropriate frequency while the power storage device is left unused.

The control unit may be configured to, when a value obtained by converting a first multiplication value of the unit discharge amount and an integer equal to or larger than 1 into a state of charge is defined as a conversion value and a minimum value of the integer that satisfies a condition that the conversion value is equal to or larger than a first threshold value is defined as a minimum integer, set a second multiplication value of the unit period and the minimum integer as the standby period. With this configuration, the minimum integer can be reduced when the unit discharge amount is large. As a result, the standby period can easily be shortened when the unit discharge amount is large.

The control unit may be configured to, when the state of charge of each of the power storage cells that has been equalized is defined as an equalized state of charge: when the conversion value is equal to or larger than the first threshold value and a difference obtained by subtracting the conversion value from the equalized state of charge is smaller than a second threshold value, prohibit the equalization process from being executed next time; and when the conversion value is equal to or larger than the first threshold value and the difference is equal to or larger than the second threshold value, execute the equalization process next time after the standby period has elapsed. With this configuration, an excessive decrease in state of charge of the power storage module due to the equalization process can be suppressed. That is, the risk of over-discharging of the power storage module can be reduced.

The control unit may be configured to: when the conversion value is equal to or larger than the first threshold value and the difference is equal to or larger than the second threshold value, determine whether the difference is within a predetermined range; and when determination is made that the difference is within the predetermined range, execute the equalization process next time after the standby period has elapsed. With this configuration, it is possible to suppress execution of the equalization process in a range of the state of charge in which the difference is larger than the predetermined range.

The control unit may be configured to, when determination is made that the difference is not within the predetermined range, increment the minimum integer and determine again, using the incremented minimum integer, whether the difference is within the predetermined range. With this configuration, the standby period can be increased by incrementing the minimum integer. As a result, the equalization process can be executed after the difference falls within the predetermined range.

According to the present disclosure, the equalization process can be executed at an appropriate frequency while the power storage device is left unused.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows the configuration of a vehicle including a power storage device according to an embodiment;

FIG. 2 shows the configuration of the power storage device according to the embodiment;

FIG. 3 shows the configuration of a power storage module of the power storage device according to the embodiment;

FIG. 4 shows an SOC-OCV curve of the power storage module (power storage cell); and

FIG. 5 is a flowchart showing control that is executed by a battery ECU of the power storage device according to the embodiment.

### DETAILED DESCRIPTION OF EMBODIMENTS

An embodiment of the present disclosure will be described in detail with reference to the drawings. The same or corresponding portions are denoted by the same signs throughout the drawings, and description thereof will not be repeated.

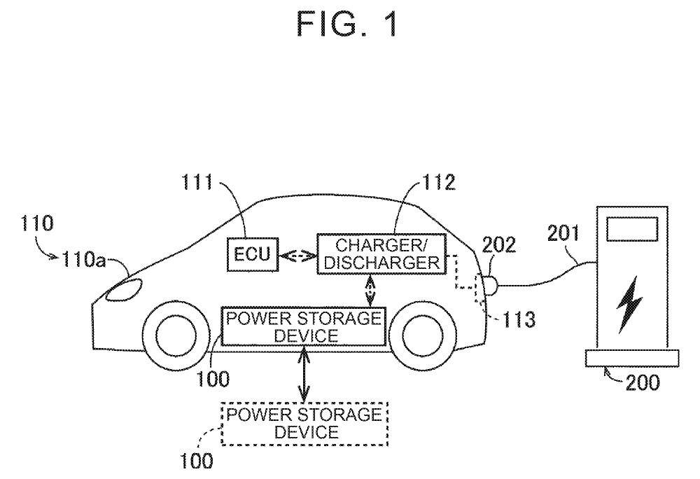

FIG. 1 shows a vehicle 110 including a power storage device 100 according to the embodiment of the present disclosure, and a power station 200 that exchanges electric power with the vehicle 110. The power storage device 100 is attachable to and detachable from the vehicle 110. The vehicle 110 is an example of an "electrical device" of the present disclosure.

The vehicle 110 includes a vehicle body 110a, an electronic control unit (ECU) 111, a charger/discharger 112, and an inlet 113.

The vehicle 110 is electrically connected to the power station 200 via a cable 201 to exchange electric power with the power station 200 (perform charging and discharging). This power exchange is performed when a plug 202 provided at the end of the cable 201 is connected to the inlet 113 of the vehicle 110.

The vehicle 110 may be, for example, a hybrid electric vehicle (HEV), a plug-in hybrid electric vehicle (PHEV), or a battery electric vehicle (BEV). The power storage device 100 may be provided in an electrical device other than the vehicle (e.g., a stationary power storage device).

In a plugged-in state, the vehicle 110 can perform external charging (charging of the power storage device 100 with electric power from the outside of the vehicle) and external discharging (discharging of electric power from the power storage device 100 to the outside of the vehicle). The vehicle 110 may perform only external charging. The charger/discharger 112 performs power conversion etc. between the power station 200 and the power storage device 100 during external charging and external discharging. This power conversion is controlled by the ECU 111.

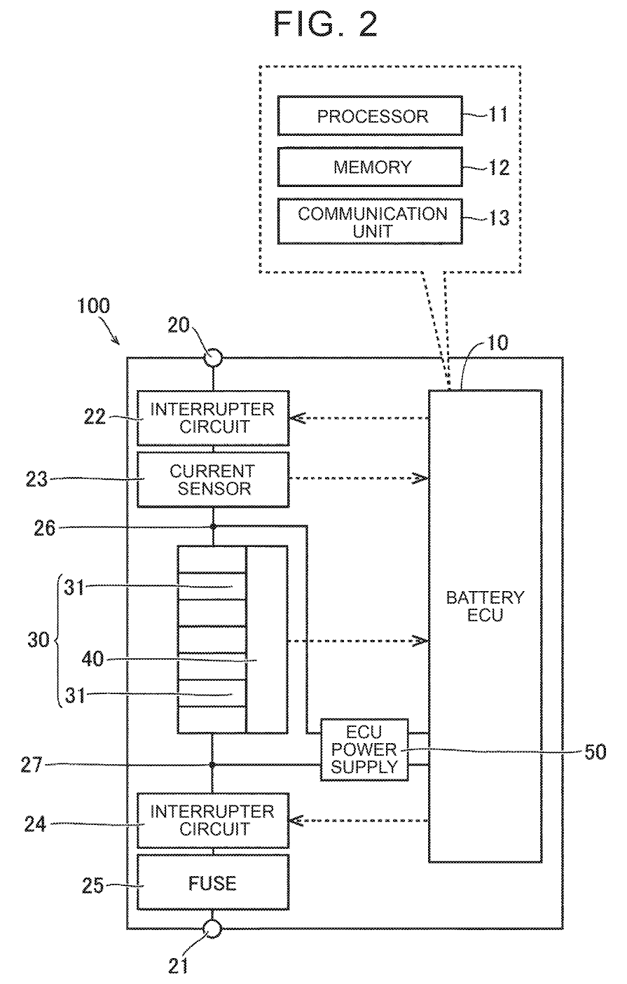

FIG. 2 shows a detailed configuration of the power storage device 100. The power storage device 100 includes a battery ECU 10, a positive terminal 20, a negative terminal 21, an interrupter circuit 22, a current sensor 23, an interrupter circuit 24, and a fuse 25. The power storage device 100 further includes a power storage module 30 including a plurality of (seven in FIG. 2) power storage cells 31, a voltage sensor 40, and an ECU power supply 50. The battery ECU 10 is an example of a "control unit" of the present disclosure.

The battery ECU 10 includes a processor 11, a memory 12, and a communication unit 13. The memory 12 is configured to retain stored information. The memory 12 stores programs and information to be used in the programs (e.g., maps, mathematical expressions, and various parameters). In the present embodiment, the processor 11 executes the programs stored in the memory 12 such that the battery ECU 10 executes various processes (e.g., an equalization process described later). These processes may be executed solely by hardware (electronic circuits) without using software.

The communication unit 13 acquires information from various devices through controller area network (CAN) communication etc. For example, the communication unit 13 acquires detection values from the voltage sensor 40 and the current sensor 23. The processor 11 transmits control signals to the interrupter circuit 22, the interrupter circuit 24, etc. based on the detection values acquired by the communication unit 13.

The power storage device 100 includes a series circuit in which the positive terminal 20, the interrupter circuit 22, the power storage module 30, the interrupter circuit 24, the fuse 25, and the negative terminal 21 are electrically arranged in this order. The current sensor 23 detects a value of a current flowing between the interrupter circuit 22 and the power storage module 30 in the series circuit.

The ECU power supply 50 supplies electric power to the battery ECU 10. The ECU power supply 50 is electrically connected to a point 26 between the current sensor 23 and the power storage module 30 in the series circuit, and to a point 27 between the power storage module 30 and the interrupter circuit 24 in the series circuit.

The power storage cells 31 are electrically connected in series. The voltage sensor 40 detects voltage values of the power storage cells 31.

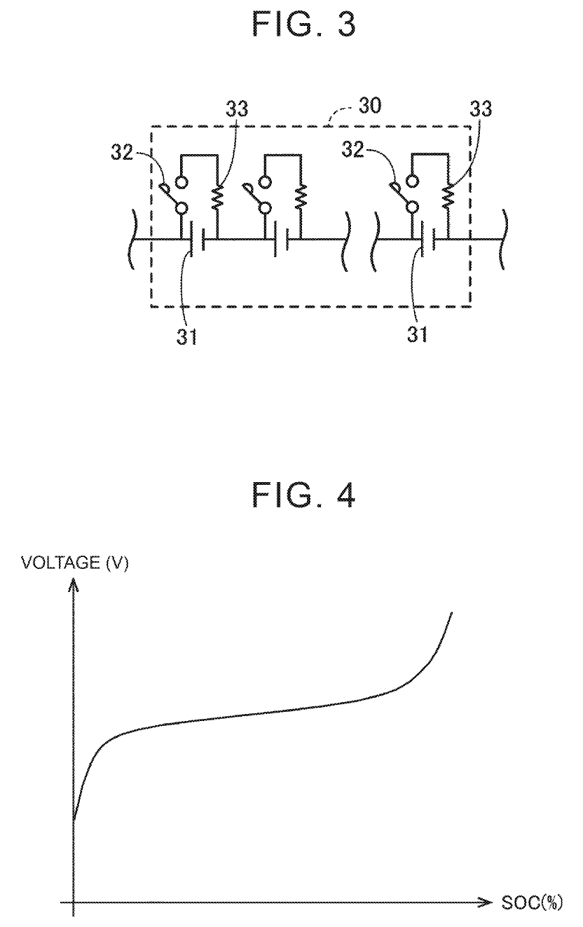

FIG. 3 schematically shows the power storage cells 31 of the power storage module 30. The power storage module 30 includes a plurality of switches 32 and a plurality of resistance elements 33. Specifically, a series circuit in which one switch 32 and one resistance element 33 are connected in series is connected in parallel to each power storage cell 31.

The open/closed state of each switch 32 is controlled by the processor 11 (FIG. 2). When the switch 32 is closed, the power storage cell 31 connected in parallel to the closed switch 32 is discharged. As a result, the SOC of the power storage cell 31 decreases. The processor 11 executes an equalization process (balancing process) for equalizing the SOCs of the power storage cells 31 by switching the power storage cells 31 to be discharged based on the SOCs of the power storage cells 31. The method for the equalization process is not limited to the above example.

FIG. 4 shows the relationship between the voltage (OCV: Open Circuit Voltage) of the power storage module 30 (power storage cell 31) and the SOC. In FIG. 4, the vertical axis represents the voltage and the horizontal axis represents the SOC. In the present embodiment, the power storage cell 31 is, for example, an iron phosphate battery (iron phosphate lithium-ion battery). Data of an SOC-OCV curve shown in FIG. 4 may be stored in the memory 12 of the battery ECU 10. The processor 11 of the battery ECU 10 may calculate the SOC of each power storage cell 31 from the voltage value of each power storage cell 31 detected by the voltage sensor 40 based on the data of the SOC-OCV curve stored in the memory 12. The method for calculating the SOC is not limited to the above example.

As shown in FIG. 4, the SOC-OCV curve of a lithium-ion battery has steep slopes in a high SOC range (e.g., 90% or higher) and a low SOC range (e.g., 30% or lower), and a shallow slope in an intermediate SOC range (e.g., 30% to 90%). The power storage cell 31 may be a battery other than the iron phosphate battery (e.g., a ternary battery).

The power storage cell 31 is gradually discharged (self-discharging) while being left unused without being externally charged or externally discharged. The self-discharge amount of the power storage cell 31 increases as the remaining charge level (SOC) of the power storage cell 31 increases. Therefore, in the high SOC range, the self-discharge amounts of the power storage cells 31 are large, and therefore the SOCs of the power storage cells 31 are likely to vary. In the low SOC range, the self-discharge amounts of the power storage cells 31 are small, and therefore the SOCs of the power storage cells 31 are less likely to vary. The self-discharge amount of the power storage cell 31 increases as the temperature of the environment in which the power storage cell 31 is left unused increases.

In the high SOC range, the change in SOC with respect to the change in voltage is relatively small. Therefore, variations in SOC are less likely to occur even when deviations occur in voltage sensing between the power storage cells 31. Thus, the accuracy of the equalization process increases in the higher SOC range.

When the equalization process is executed excessively frequently, the power consumption required to execute the equalization process increases, and the electric power stored in the power storage cells 31 is released due to the equalization process, which is an inconvenience. When the frequency of the equalization process is excessively low, the difference in SOC cannot be eliminated. Therefore, it is desirable to execute the equalization process at an appropriate frequency while the power storage device is left unused.

In the present embodiment, the battery ECU 10 sets a standby period when a unit discharge amount is large to be shorter than a standby period when the unit discharge amount is small. In the present embodiment, the unit discharge amount refers to the self-discharge amount of the power storage module 30 per day. In the present embodiment, the standby period means a period until the next equalization process is executed. The value "one day" is an example of a "unit period" of the present disclosure.

Therefore, the frequency of the equalization process can be increased in the high SOC range in which an SOC variation is likely to occur between the power storage cells 31 and the accuracy of the equalization process is high, and the frequency of the equalization process can be reduced in the low SOC range in which an SOC variation is less likely to occur between the power storage cells 31 and the accuracy of the equalization process is low. As a result, the equalization process can be executed at an appropriate frequency while the power storage device 100 is left unused.

### Control Flow

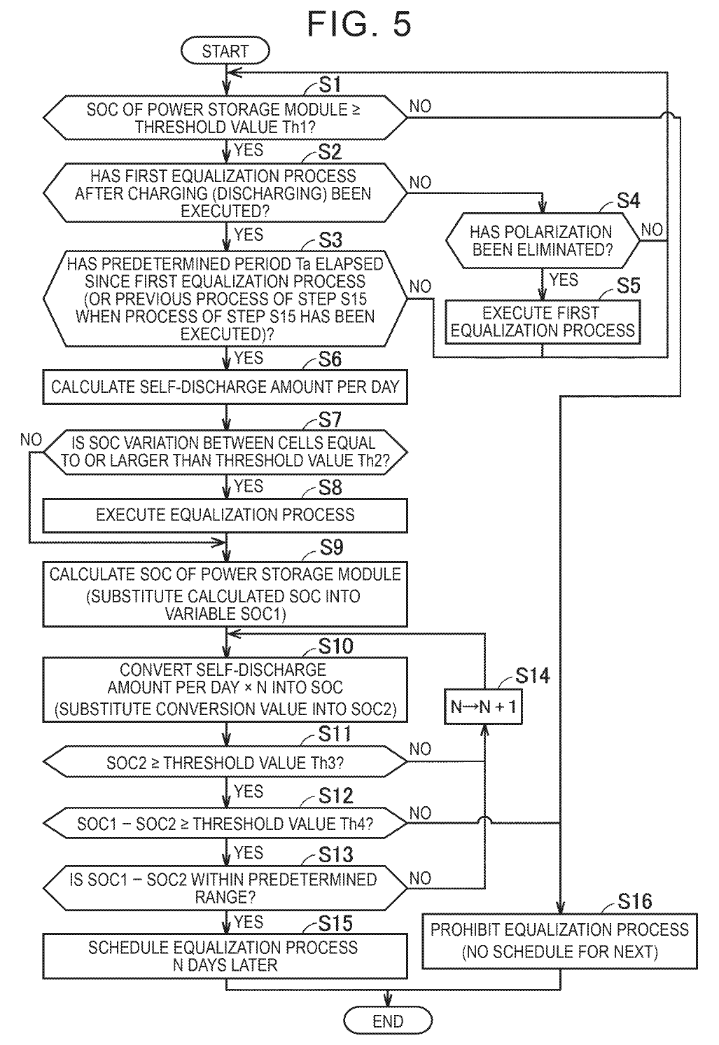

FIG. 5 is a flowchart showing a process in the power storage device 100 according to the present embodiment. This control flow is executed by the battery ECU 10 (processor 11). The control flow shown in FIG. 5 is executed while the power storage device 100 is detached from the vehicle 110 and left unused alone.

In step S1, the battery ECU 10 determines whether the SOC of the power storage module 30 is equal to or larger than a threshold value Th1 (e.g., 30%). When the SOC of the power storage module is equal to or larger than the threshold value Th1 (Yes in S1), the process proceeds to step S2. When the SOC of the power storage module is smaller than the threshold value Th1 (No in S1), the process proceeds to step S16. In the following description, the SOC of the power storage module 30 refers to an average value of the SOCs of the power storage cells 31.

In step S2, the battery ECU 10 determines whether the first equalization process after charging (external charging) or discharging (external discharging) has been executed. The battery ECU 10 (processor 11) may make this determination based on an execution history of the equalization process and an execution history of charging (discharging) stored in the memory 12. When the first equalization process has been executed (Yes in S2), the process proceeds to step S3. When the first equalization process has not been executed (No in S2), the process proceeds to step S4.

In step S3, the battery ECU 10 determines whether a predetermined period Ta has elapsed since the first equalization process (or the previous process of step S15 when the process of step S15 described later has been executed). When the process of step S15 has not been executed, the predetermined period Ta may be, for example, three days from the first equalization process. When the process of step S15 has been executed, the predetermined period Ta may be N days from the previous process of step S15. When the predetermined period Ta has elapsed (Yes in S3), the process proceeds to step S6. When the predetermined period Ta has not elapsed (No in S3), the process returns to step S1.

In step S4, the battery ECU 10 determines whether the polarization of the power storage module 30 (power storage cells 31) has been eliminated. For example, the battery ECU 10 may determine that the polarization has been eliminated when a predetermined period (period required to eliminate the polarization) has elapsed from the time at which charging (external charging) or discharging (external discharging) was completed. When determination is made that the polarization has been eliminated (Yes in S4), the process proceeds to step S5. When determination is made that the polarization has not been eliminated (No in S4), the process returns to step S1.

In step S5, the battery ECU 10 executes the first equalization process. The process then returns to step S1.

In step S6, the battery ECU 10 calculates a self-discharge amount per day (hereinafter referred to as "unit discharge amount"). Specifically, when the process of step S15 has not been executed, the battery ECU 10 calculates the unit discharge amount by dividing a difference obtained by subtracting the SOC of the power storage module 30 at the time of step S6 from the SOC of the power storage module 30 at the time of execution of the previous equalization process by the predetermined period Ta (i.e., 3) in step S3. When the process of step S15 has been executed, the battery ECU 10 calculates the unit discharge amount by dividing a difference obtained by subtracting the SOC of the power storage module 30 at the time of step S6 from the SOC of the power storage module 30 at the time of previous step S15 by the predetermined period Ta (i.e., N) in step S3.

In step S7, the battery ECU 10 determines whether an SOC variation between the power storage cells 31 is equal to or larger than a threshold value Th2 (e.g., 5%). For example, the battery ECU 10 may determine whether a difference between the average value of the SOCs of all the power storage cells 31 and the SOC that is farthest from the average value is equal to or larger than the threshold value Th2. When the SOC variation between the power storage cells 31 is equal to or larger than the threshold value Th2 (Yes in S7), the process proceeds to step S8. When the SOC variation between the power storage cells 31 is smaller than the threshold value Th2 (No in S7), determination is made that the SOCs have been equalized, and the process proceeds to step S9.

In step S8, the battery ECU 10 executes the equalization process. The process then proceeds to step S9. During the execution of the equalization process (discharging) in step S8, the battery ECU 10 may be put into a sleep state (OFF state) to reduce the power consumption. The battery ECU 10 may be restarted after the equalization process is completed (after discharging). In this case, the process may be resumed from step S9.

In step S9, the battery ECU 10 calculates the SOC of the power storage module 30 and substitutes the calculated SOC into a variable SOC1. The SOC calculated in step S9 is an example of an "equalized SOC" of the present disclosure.

In step S10, the battery ECU 10 calculates a multiplication value of the unit discharge amount calculated in step S6 and N that is an integer equal to or larger than 1, and calculates a conversion value by converting the multiplication value into the SOC of the power storage cell 31. Then, the battery ECU 10 substitutes the conversion value into a variable SOC2. The initial value of N is 1.

In step S11, the battery ECU 10 determines whether SOC2 is equal to or larger than a threshold value Th3. When SOC2 is equal to or larger than the threshold value Th3 (Yes in S11), the process proceeds to step S12. When SOC2 is smaller than the threshold value Th3 (No in S11), the process proceeds to step S14. The threshold value Th3 is an example of a "first threshold value" of the present disclosure.

For example, the threshold value Th3 may be set to a value that is smaller than the unit discharge amount in the high SOC range (e.g., 90% or higher) and larger than the unit discharge amount in the intermediate SOC range (e.g., 30% to 90%). Therefore, in the high SOC range, the determination in step S11 is more likely to be "Yes" even when N is small. In the intermediate SOC range, the determination in step S11 is likely to be "No" when N is small. The threshold value Th3 may be a fixed value that is set in advance based on design data of the power storage cell 31, etc. The battery ECU 10 may periodically calculate (update) the threshold value Th3 based on history information of unit discharge amounts during past self-discharging.

In step S12, the battery ECU 10 determines whether a difference obtained by subtracting SOC2 from SOC1 is equal to or larger than a threshold value Th4. When the difference is equal to or larger than the threshold value Th4 (Yes in S12), the process proceeds to step S13. When the difference is smaller than the threshold value Th4 (No in S12), the process proceeds to step S16. The threshold value Th4 may be equal to the threshold value Th1, or may be slightly smaller than the threshold value Th1 (e.g., threshold value Th1 − 5%). The threshold value Th4 is an example of a "second threshold value" of the present disclosure.

In step S13, the battery ECU 10 determines whether the difference in step S12 is within a predetermined range. The upper limit value of the predetermined range may be a value within the high SOC range (e.g., 95%). The lower limit value of the predetermined range may be the threshold value Th4 or a value slightly larger than the threshold value Th4 (e.g., threshold value Th4 + 5%). In step S13, determination may be made as to only whether the difference is equal to or smaller than the upper limit value. When the difference is within the predetermined range (Yes in S13), the process proceeds to step S15. When the difference is not within the predetermined range (No in S13), the process proceeds to step S14.

In step S14, the battery ECU 10 increments N. That is, the battery ECU 10 increases the value of N by one. The process then returns to step S10.

In step S15, the battery ECU 10 schedules the execution of the next equalization process N days later. The process then ends. The value "N days" is an example of the "standby period" of the present disclosure.

In step S16, the battery ECU 10 prohibits the next equalization process. That is, the battery ECU 10 does not schedule the next equalization process. The process then ends.

After the processes of steps S15 and S16 are executed, the control flow shown in FIG. 5 may be executed again after a predetermined period of time has elapsed. The predetermined period may be a period set in advance (e.g., one day), or may be N days when step S15 has been executed in the previous control flow. The battery ECU 10 may be in the sleep state until the control flow shown in FIG. 5 is executed again. After step S15 is executed, the equalization process may be executed N days after step S15 without executing the control flow shown in FIG. 5 again.

As can be seen from steps S11 and S13, when the unit discharge amount (SOC2) is small, the process proceeds to step S14 and N is incremented. Therefore, the battery ECU 10 sets the standby period (N days) until the next equalization process when the unit discharge amount is large to be shorter than the standby period (N days) until the next equalization process when the unit discharge amount is small.

As described above, in the present embodiment, the battery ECU 10 sets the standby period (N days) when the unit discharge amount is large to be shorter than the standby period (N days) when the unit discharge amount is small. Therefore, the equalization process can be executed more frequently when the SOC variation is large and the accuracy of the equalization process is high. As a result, the SOC variation between the power storage cells 31 can further be reduced. Therefore, the equalization process can be executed less frequently when the SOC variation is small and the accuracy of the equalization process is low. As a result, it is possible to suppress highly frequent execution of the equalization process when the need for the equalization process is low. Thus, the power consumption from the power storage device 100 can be reduced and unnecessary loss of the electric power stored in the power storage cells 31 due to the equalization process can be suppressed.

### Modifications

The above embodiment illustrates the example in which the period until the next equalization process is determined based on the self-discharge amount per day, but the present disclosure is not limited to this. The period until the next equalization process may be determined based on a self-discharge amount per period other than one day (e.g., one hour).

The above embodiment illustrates the example in which the control flow shown in FIG. 5 is executed while the power storage device 100 is detached from the vehicle 110 and left unused alone, but the present disclosure is not limited to this. This control flow may be executed while the power storage device 100 is attached to the vehicle 110 without charging, discharging, traveling, etc.

The above embodiment illustrates the example in which the unit discharge amount is calculated in step S6 by dividing the amount of change in SOC by the predetermined period Ta in step S3, but the present disclosure is not limited to this. The unit discharge amount may be calculated by dividing a value obtained by correcting the amount of change in SOC with a coefficient based on the ambient temperature of the power storage device 100 by the predetermined period Ta. For example, when the ambient temperature is higher than a reference temperature (e.g., 20°C), correction may be made to increase the amount of change in SOC using a coefficient based on the ambient temperature and the reference temperature. When the ambient temperature is lower than the reference temperature, correction may be made to reduce the amount of change in SOC using a coefficient based on the ambient temperature and the reference temperature. Therefore, the standby period until the next equalization process when the ambient temperature is high can be made shorter than that when the ambient temperature is low. As a result, when the SOCs of the power storage cells 31 are likely to vary due to high ambient temperature, the frequency of execution of the equalization process can be increased.

The above embodiment illustrates the example in which the timing of the next equalization process is determined using the control flow shown in FIG. 5, but the present disclosure is not limited to this. The timing of the next equalization process may be determined without using the control flow shown in FIG. 5. For example, the standby period until the next equalization process may be determined from the self-discharge amount per unit period (e.g., one day) using a map showing the relationship between the self-discharge amount per unit period and the standby period. This map is designed such that the standby period decreases as the self-discharge amount per unit period increases.

The configurations of the above embodiment and modifications may be combined with each other.

The embodiment disclosed herein should be considered to be exemplary in all respects and not restrictive. The scope of the present disclosure is set forth in the claims rather than in the above description of the embodiment, and is intended to include all modifications within the meaning and scope equivalent to the claims.

What is claimed is:

1. A power storage device attachable to and detachable from an electrical device, the power storage device comprising:
a power storage module including a plurality of power storage cells; and
a control unit configured to execute an equalization process for equalizing states of charge of the power storage cells, wherein
the control unit is configured to, when a self-discharge amount of the power storage module per unit period is defined as a unit discharge amount and a period until the equalization process is executed next time is defined as a standby period, set the standby period when the unit discharge amount is large to be shorter than the standby period when the unit discharge amount is small.

2. The power storage device according to claim 1, wherein the control unit is configured to, when a value obtained by converting a first multiplication value of the unit discharge amount and an integer equal to or larger than 1 into a state of charge is defined as a conversion value and a minimum value of the integer that satisfies a condition that the conversion value is equal to or larger than a first threshold value is defined as a minimum integer, set a second multiplication value of the unit period and the minimum integer as the standby period.

3. The power storage device according to claim 2, wherein the control unit is configured to, when the state of charge of each of the power storage cells that has been equalized is defined as an equalized state of charge:
when the conversion value is equal to or larger than the first threshold value and a difference obtained by subtracting the conversion value from the equalized state of charge is smaller than a second threshold value, prohibit the equalization process from being executed next time; and
when the conversion value is equal to or larger than the first threshold value and the difference is equal to or larger than the second threshold value, execute the equalization process next time after the standby period has elapsed.

4. The power storage device according to claim 3, wherein the control unit is configured to:
when the conversion value is equal to or larger than the first threshold value and the difference is equal to or larger than the second threshold value, determine whether the difference is within a predetermined range; and
when determination is made that the difference is within the predetermined range, execute the equalization process next time after the standby period has elapsed.

5. The power storage device according to claim 4, wherein the control unit is configured to, when determination is made that the difference is not within the predetermined range, increment the minimum integer and determine again, using the incremented minimum integer, whether the difference is within the predetermined range.
